(19) United States
(12) Patent Application Publication
(10) Pub. No.: US 2011/0126801 A1
(43) Pub. Date: Jun. 2, 2011

(54) METHOD AND DEVICE FOR OPERATING AN INTERNAL COMBUSTION ENGINE

(76) Inventor: Frank Walter, Ilsfeld (DE)

(21) Appl. No.: 12/946,707

(22) Filed: Nov. 15, 2010

(30) Foreign Application Priority Data
Nov. 27, 2009 (DE) 102009047219.3

(51) Int. Cl. F02P 5/04

(52) U.S. Cl. 123/406.2

(57) ABSTRACT

A method for operating an internal combustion engine having several cylinders, successive time windows, each of which is assigned to a cylinder being defined in a control unit in one time window, a calculation of an ignition time, a start of a charging process for an ignition device, and a triggering of an ignition for a cylinder assigned to the time window being performed; it being necessary for an ignition to start the charging process for the ignition device, the extent of which is at least as long as one time period needed for charging; the following steps being carried out in each time window: ascertaining information for an ignition time for a cylinder assigned to the subsequent time window; establishing whether the ignition time for the cylinder assigned to the subsequent time window is after the beginning of the subsequent time window by at least the time needed for charging; if it is established that the ignition time for the cylinder assigned to the subsequent time window is after the beginning of the subsequent time window by less than the time needed for charging, then starting of a charging process for the ignition device of the cylinder assigned to the subsequent time window.

### CROSS REFERENCE

The present application claims the benefit under 35 U.S.C. §119 of German Patent Application No. 102009047219.3 filed on Nov. 27, 2009, which is expressly incorporated herein by reference in its entirety.

### FIELD OF THE INVENTION

The present invention relates to internal combustion engines, in particular methods for operating internal combustion engines having torque compensation using an adjustment to an ignition angle.

### BACKGROUND INFORMATION

Internal combustion engines, in particular spark-ignition gasoline engines, may be operated in various engine operating modes, in each of which a different number of cylinders is operated actively so that they contribute to torque, while the remaining cylinders are passive and do not deliver any torque. The operating mode in which all cylinders of the internal combustion engine are active, i.e., are supplying a contribution to torque, is called full-engine operation, while the operating mode in which only part of the cylinders are active is called partial-engine operation. In the passive cylinders, the piston is merely dragged along by the motion of the crankshaft.

In the transition between engine operating modes, shutting down or restarting individual cylinders causes torque jumps to occur, which must be compensated for. In addition, the passive cylinders may remain closed during partial-engine operation; i.e., both the intake valve and the exhaust valve of the cylinder in question may be kept continuously closed, so that in the transition to partial-engine operation, in which previously operated active cylinders are shut down, combustion gases and/or fresh air remain in the combustion chamber of the corresponding cylinder. As the piston moves in the passive cylinder, when the residual exhaust gases in the cylinder are compressed as the piston is dragged along, a high torque is produced which is opposite to the torque provided by the active cylinders. In the same way, a torque which acts in the direction of the drive torque is provided by the passive cylinders during an expansion motion.

These torques brought about by the motion of the pistons in the passive cylinders must be compensated for, in order to avoid severe torque fluctuations on the output shaft. This process is also known as gas spring compensation. Gas spring compensation is used to level out the torque fluctuations brought about by the passive cylinders by activating the active cylinders appropriately. Gas spring compensation is executed by using the reserve torque built up prior to switching over between the engine operating modes in order to carry out a quick torque intervention. This may be done by adjusting the ignition angle.

The individual cylinders in an internal combustion engine are controlled by a control unit. In order to ensure that all values needed for operating the internal combustion engine are made available at the right time, the determination and execution of individual interventions pertaining to the cylinders take place in successive time windows, with each time window being allocated predominantly to a corresponding cylinder. In the first place, the time windows serve the cylinder currently involved in producing torque, for example in providing the ignition time. In the second place, however, they also serve other cylinders, which must be prepared so that they may produce torque at a later point in time, for example providing the injection point in time. This means that the control unit ascertains control values such as an injection point in time, an injection duration, an ignition time and the like, and a corresponding activation of the cylinder assigned to the time window only in the appropriate time window. Thus, the ascertainment of control values and a corresponding activation for various cylinders are carried out in successive time windows. These time windows are called synchros.

An ignition spark produced by an ignition coil provided in each of the cylinders cannot be triggered directly according to an activating signal. Rather, the ignition coil must first be charged, so that an ignition spark may be triggered after a minimum charging time. It is therefore necessary to first determine a starting point in time for charging, depending on a desired ignition time, and to start the charging of the ignition coil accordingly, in order to enable ignition at the predetermined ignition time.

Depending on the operating state of internal combustion engines that may be operated in partial-engine operation, such as operation in a particular speed range, it is not possible to implement the gas spring compensation if an ignition overlap occurs. Such an ignition overlap occurs when an ignition time is ascertained that would necessitate starting the process of charging the ignition coil already during a preceding synchro. In these cases a so-called forced event therefore occurs, wherein the charging of the ignition coil is started immediately upon entry into the current synchro. However, the resulting ignition spark cannot be produced until later than ascertained in the synchro. This results in a lower torque than desired, since the ignition time cannot be advanced sufficiently. The intended gas spring compensation is thus only executed inadequately.

If there has been such a forced event, the ignition system subsequently assumes that future ignitions should also be started with an overlap, i.e., by starting a process of charging the ignition coil for the cylinder assigned to a subsequent synchro. However, with gas spring compensation the ignition time of the following ignition is sometimes already adjusted again from an early ignition time to a late ignition time. The ignition overlap is therefore withdrawn again. But since the ignition system still assumes an ignition overlap, a synchro is already begun beforehand with the charging of the ignition coil. Since ignition coils normally cannot be discharged without releasing an ignition spark, the ignition spark must be set off. But the point in time at which the ignition spark is produced in this case is too early in the synchro in question, and the torque produced thereby is too high.

Since rapid jumps of the ignition points in time must be realized with gas spring compensation, it is not possible with conventional ignition systems to implement gas spring compensation in such a way that the entire torque caused by the passive cylinders is compensated for.

### SUMMARY

An object of the present invention is to make available a method and a device for operating an internal combustion engine wherein the production of an ignition spark may be realized at any desired ignition time within a synchro.

According to a first aspect of the present invention, an example method for operating an internal combustion engine having a plurality of cylinders is provided, wherein in a control unit successive time windows are defined, each of which may be assigned to a cylinder; in each time window, a calculation of an ignition time, a start of a charging process for an ignition device, and a triggering of an ignition for a cylinder assigned to a time window being performed; it being necessary for an ignition to start the charging process for the ignition device, the extent of which is at least one time period needed for charging,
the following steps being executed in each time window:
ascertaining information for an ignition time for a cylinder assigned to the subsequent time window,
establishing whether the ignition time for the cylinder assigned to the subsequent time window is after the beginning of the subsequent time window by at least the time needed for charging,
if it is established that the ignition time for the cylinder assigned to the subsequent time window is after the beginning of the subsequent time window by less than the time needed for charging, then starting of a charging process for the ignition device of the cylinder assigned to the subsequent time window.

In accordance with the present invention, an ignition time is predicted for the cylinder assigned to a particular time window during a time window that precedes the time window assigned to that particular cylinder, so that depending on the predicted ignition time, the ignition system may decide in the preceding synchro whether or not it should begin charging the ignition coil. In this way it is possible to produce ignition sparks even immediately at the beginning of the time window of the cylinder assigned to the current time window, since the charging of the respective ignition device was already started in the preceding time window. In this way it is possible to quickly adjust the ignition time over the entire range of the time window. That makes it possible, for example, to implement gas spring compensation when switching between engine operating modes so that torque-neutral switching between the engine operating modes is enabled, even though that necessitates rapid jumps of the ignition points in time.

Furthermore, a charging process for the ignition device of the cylinder assigned to the subsequent time window may begin at a point in time that precedes the ignition time by at least the time needed for charging.

According to one specific example embodiment, the starting of the charging process for the ignition device of the cylinder assigned to the current time window may be suppressed, if it is established that the charging process for the ignition device of the current cylinder has already been started.

In one engine operating mode, at least one of the cylinders may be passive and the other cylinders active, in which case the torque caused by the at least one passive cylinder is taken into account when establishing whether the ignition time for the cylinder assigned to the subsequent time window is after the beginning of the subsequent time window by at least the time needed for charging.

Furthermore, starting a charging process for an ignition device and triggering an ignition may be suppressed in the time window that is assigned to the at least one passive cylinder.

In particular, the respective time window may include the point in time of the top dead center of a motion of a piston in the cylinder assigned to the time window.

According to an additional aspect of the present invention, an example control unit for operating an internal combustion engine having several cylinders is provided, the control unit being designed so that in successive time windows, each of which is assigned to a cylinder, an ignition time, a start of a charging process for an ignition device, and a triggering of an ignition for a cylinder assigned to a time window are calculated, the charging process, which lasts at least as long as the time needed for charging the ignition device, must be started for an ignition,

the control unit being further designed so as, in each time window:
to ascertain information for an ignition time for a cylinder assigned to the subsequent time window,
to establish whether the ignition time for the cylinder assigned to the subsequent time window is after the beginning of the subsequent time window by at least the time needed for charging,
if it is established that the ignition time for the cylinder assigned to the subsequent time window is after the beginning of the subsequent time window by less than the time needed for charging, then starting of a charging process for the ignition device of the cylinder assigned to the subsequent time window is triggered.

According to another aspect of the present invention, an example engine system having an internal combustion engine and the above-mentioned control unit is provided.

According to another aspect of the present invention, an example computer program is provided that contains a computer program which carries out the above-mentioned method when it is executed on a data processing unit.

### BRIEF DESCRIPTION OF THE DRAWINGS

Preferred specific embodiments will now be explained in greater detail with reference to the figures.

FIG. 1 shows a schematic depiction of an engine system having an internal combustion engine which may be operated in an engine operating mode with some of the cylinders shut down.

FIG. 2 shows a diagram for depicting the assignment of the synchro to the individual cylinders.

FIG. 3 shows a flow chart for illustrating the method for operating the engine system of FIG. 1.

### DETAILED DESCRIPTION OF EXAMPLE EMBODIMENTS

FIG. 1 schematically shows an engine system 1 having an internal combustion engine 2, which, in the exemplary embodiment shown, has four cylinders Z1 through Z4. Air is supplied to cylinders Z1 through Z4 via an air supply system 3, it being possible to adjust the volume of air using a throttle valve 4. Exhaust gases are removed from cylinders Z1 through Z4 via an exhaust gas system 5.

Injection valves 6 are situated at cylinders Z1 through Z4, to inject fuel. As an alternative to this so-called direct injection, the fuel may also be injected in an intake manifold section of air supply system 3. In addition, cylinders Z1 through Z4 are provided with ignition devices 7, such as spark plugs, which, under the control of a control unit 10, are able to generate an ignition spark to ignite an air-fuel mixture present in the particular cylinder Z1 through Z4.

It is possible to adjust the torque provided by internal combustion engine 2 by varying the supply of air to cylinders Z1 through Z4 with the aid of throttle valve 4. In addition, it is also possible to adjust the torque provided by internal combustion engine 2 by changing an ignition time.

In full-engine operation, cylinders Z1 through Z4 are operated in a staggered sequence according to a four-stroke process.

Each of cylinders Z1 through Z4 in succession carries out a compression stroke to compress fresh air in cylinder Z1 through Z4, a power cycle to burn an air-fuel mixture in cylinder Z1 through Z4, an exhaust stroke to discharge exhaust gas from cylinder Z1 through Z4, and an intake stroke to draw in fresh air. As a result of the staggering of the four-stroke operation of individual cylinders Z1 through Z4, in the engine system shown only one of cylinders Z1 through Z4 is in the power cycle. In engine systems wherein internal combustion engine 2 has more than four cylinders, it is also possible for more than one cylinder to be in the power cycle at a time. For example, in an 8-cylinder engine two cylinders may be operated synchronously, so that there is no staggering of their operating strokes.

Modern internal combustion engines may be operated in various engine operating modes, in which individual cylinders are shut down. When a cylinder is shut down, the intake and exhaust valves of the particular cylinder may be kept closed, in which case the exhaust valve is not opened again after the end of the last combustion in the particular cylinder. Subsequently, the exhaust gases present in the cylinder may be alternately compressed and expanded by the turning of the crankshaft (not shown), in which case additional torque is necessary for compression, which is released again during the expansion.

The switchover from full-engine operation, in which all cylinders Z1 through Z4 are operated actively, to partial-engine operation, in which at least one of the cylinders is switched to passive, i.e., in which the exhaust gases are not discharged after the last combustion of an air-fuel mixture and no injection occurs subsequently, should normally take place in a torque-neutral manner; that is, a driver of a vehicle operated by engine system 1 should not feel any change of torque during the switchover between operating modes. This is achieved by increasing the charge of air in the cylinders before the switchover, in order to build up a reserve of torque. While the air charge is being increased, the ignition time in the cylinders is retarded relative to the top dead center of the piston in the respective cylinder Z1 through Z4; i.e., it is shifted to a later point in time in the direction of motion of the piston. If the switchover now takes place and one of cylinders Z1 through Z4 is switched to passive, that cylinder is no longer contributing any drive torque, so that the other cylinders must absorb the loss of drive torque due to the shut-down cylinder by increasing the torque which they contribute. This is done by a quick intervention in the torque, which is executed by advancing the ignition time to an early ignition time.

In addition, the exhaust gas enclosed in the one or more passive cylinders causes a so-called gas spring torque, which is brought about by the compression and expansion of the combustion chambers of the passive cylinders. This gas spring torque must be compensated for by gas spring compensation. The compensation for the gas spring torque is accomplished by a rapid intervention in the torque, which results in an advancing of the ignition time of the cylinder in the power cycle (opposite to the direction of motion of the piston) during compression of the exhaust gas in the combustion chambers of the passive cylinders, and which results in retarding the cylinder which is in the power cycle at the moment (in the direction of the bottom dead center) during expansion of the combustion chambers of one or more of the passive cylinders.

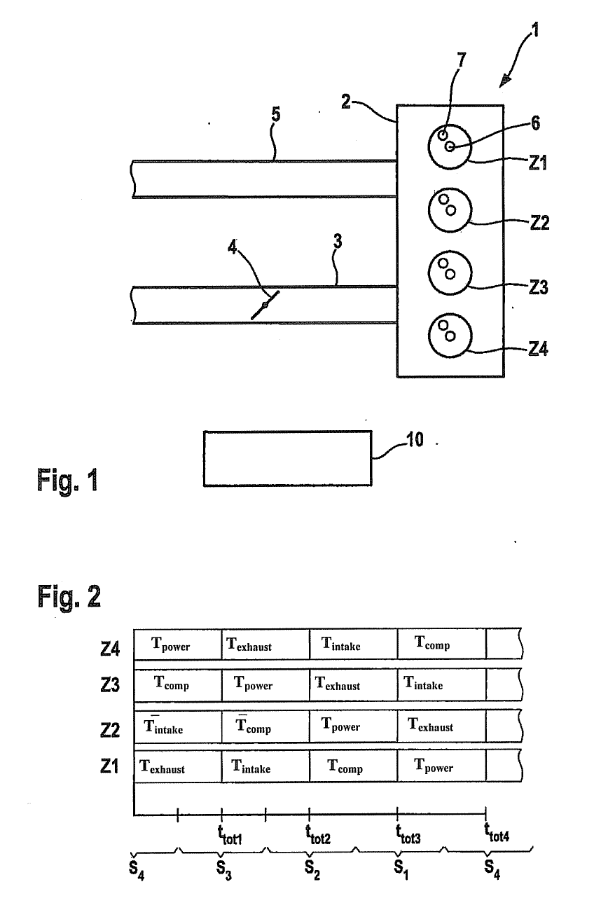

FIG. 2 shows a diagram that depicts the individual cycles of the four cylinders Z1 through Z4 over time, with the individual cycles proceeding in a staggered sequence. Each of the strokes denotes a motion of a piston between a top and a bottom dead center, or vice versa. It is apparent that in a four-cylinder internal combustion engine there is always only one of the four cylinders Z1 through Z4 that is executing a power cycle in order to provide torque. To perform time controls relating to one of cylinders Z1 through Z4, time windows are defined in which control unit 10 controls time sequences for a particular one of the cylinders, which is in the compression stroke T_{comp}. Such a time window is called a synchro. In other words, control unit 10 executes a sequence of synchros, each of the synchros being assigned to one of the cylinders. The timing for each of synchros S₁ through S₄ is chosen so that an earliest possible ignition time and a latest possible ignition time for the assigned cylinder fall within the respective synchro.

If the individual cycles of the four-stroke operation relate to a crankshaft rotation of 180° (as is the case when there are four cylinders), synchros S₁ through S₄ correspond to a length of time that results from a motion of a piston between two dead centers. In particular, synchros S₁ through S₄ are situated relative to the cycles of the four-stroke operation so that a synchro begins at a point in time when a particular crankshaft angle before the top dead center is reached, and ends at a point in time when a crankshaft angle that is 180° greater is reached. In particular, a synchro for a particular cylinder may begin at a crankshaft angle of 90° before the top dead center before the beginning of the power cycle, and may end at a crankshaft angle of 90° after the top dead center in question, i.e., within the power cycle. The above applies to a four-cylinder engine. It is true in general that the duration of the synchro is 720° (corresponding to two revolutions of the crankshaft, i.e., the duration of the four operating cycles of the internal combustion engine) divided by the number of cylinders.

When switching over from full-engine operation, in which all cylinders Z1 through Z4 are in operation, to partial-engine operation, in which for example cylinders Z2 through Z4 are operated and cylinder Z1 is switched to passive, after the power cycle T_{power} of cylinder Z1 the exhaust valve of cylinder Z1 when bottom dead center t_{dead4} is reached, and the intake valves and exhaust valves of cylinder Z1 are kept closed as long as the partial-engine operation continues. The exhaust gases that remained in the combustion chamber of cylinder Z1 with the last power cycle T_{power} are alternately compressed and expanded, so that this cylinder Z1 acts like a gas spring. The gas spring causes a positive (driving) torque (gas spring torque) during expansion of the combustion chamber, and a negative (decelerating) gas spring torque, which acts in the direction of the load torque, during compression of the combustion chamber of this cylinder Z1.

While no ignition time is defined in synchro S₁, in synchros S₂ through S₄ ignition points in time are established in such a way that they take the particular acting gas spring torque of inactive cylinder Z1 into account. This means that in the active synchro, which begins before a compression stroke or before an exhaust stroke of inactive cylinder Z1, the additional torque needed to compress the exhaust gas in shut-down cylinder Z1 must be produced through an appropriate adjustment of the ignition time. If the active synchro begins at a point in time which is earlier than an expansion stroke of inactive cylinder Z1, this must be allowed for by adjusting the ignition time accordingly. For this reason, the ignition points in time must be shifted very rapidly in order to execute a gas spring compensation.

The value of the ignition time is ascertained, for example, using a function that generates an offset for the ignition time, depending on whether the synchro in question is simultaneous with a compression or an expansion of the gas spring. The offset for the ignition time is added to the current ignition time that results from the conventional engine control.

Firing an ignition device 7 necessitates a minimum charging time for the ignition coil provided therein, which must be observed in order to produce an ignition spark. Furthermore, the ignition process also cannot be aborted after charging of the ignition coil has begun, but rather an ignition spark must be produced. It may happen that the ignition spark must be produced very early in the synchro due to a compression of the combustion chamber of inactive cylinder Z1. If this is established only during (or at the beginning of) the synchro in question, then the time remaining until the ignition time may be so short that the minimum charging time of the ignition coil may possibly not be met. Even if the charging process for the ignition coil is started immediately in this case, the ignition spark is released too late in this synchro. Such a case may occur in particular at high rotational speeds, when the duration of the synchro, which is based on the angular range of the motion of the piston and therefore depends on the speed of rotation, is reduced.

For this reason, there is provision for a prediction to be carried out for each of the synchros assigned to active cylinders Z2 through Z4, in which it is ascertained when in the subsequent synchro an ignition spark is to be set off.

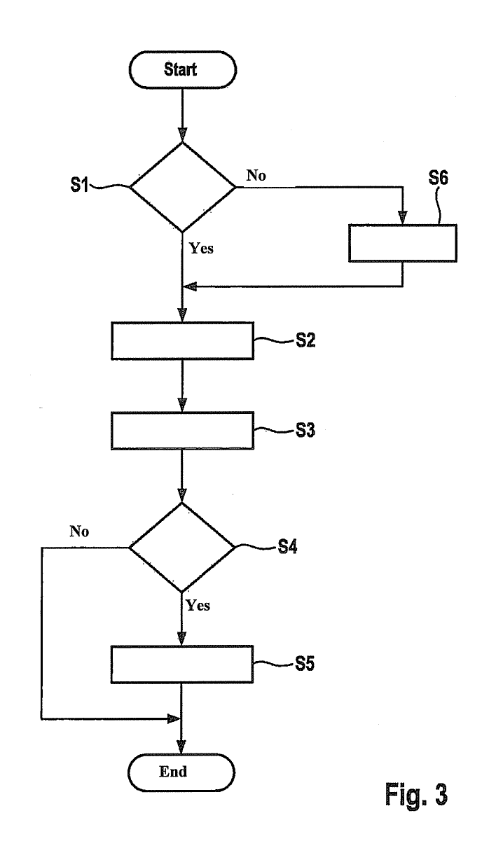

FIG. 3 shows a flow chart for illustrating an example method for operating an internal combustion engine in partial-engine operation. The method relates to the process steps within a current synchro that is assigned to a current cylinder. Step S1 checks whether a charging process for the ignition coil of the ignition device of the current cylinder has been started.

If this is the case (alternative: Yes), then in step S2 information about a predicted ignition time is acquired from the preceding synchro, and the air-fuel mixture is ignited when the predicted ignition time has been reached. If it is established in step S1 that a charging process has not been started (alternative: No), then the required ignition time for the current cylinder is ascertained and the charging of the ignition coil is started with the appropriate speed-up (step S6), so as to be able to release the ignition spark on time at the intended ignition time.

In addition, in step S3 a prediction is made as to the ignition time at which the ignition is to occur in the next cylinder to go into the power cycle.

If it is established in step S4, allowing in particular for the rotational speed of internal combustion engine 2, that the ignition spark is to be set off at a point in time within the next synchro when it is not possible to provide sufficient charging time within the next synchro for the ignition coil (alternative: Yes), then charging of the ignition coil for the cylinder assigned to the subsequent synchro is begun in step S5 for the current synchro. For the exemplary embodiment described above, this means that it is already ascertained or predicted in synchro S3 at what ignition angle an ignition is to take place in cylinder Z2. Since cylinder Z2 has a power cycle that is simultaneous with a compression stroke of shut-down cylinder Z1, in current synchro S3 an advancing of the ignition time is ascertained. If the ignition time thus ascertained falls within the subsequent synchro S2 at a point in time which does not guarantee a charging process for a minimum charging time of the ignition device, allowing for the current speed of rotation, then the charging process for the ignition device of cylinder Z2 is started already during synchro S₃.

What is claimed is:

1. A method for operating an internal combustion engine having a plurality of cylinders wherein successive time windows, each of which is assigned to a cylinder, are defined in a control unit, wherein, in each time window, the following is performed:
ascertaining information for an ignition time for a cylinder assigned to a subsequent time window;
establishing whether the ignition time for the cylinder assigned to the subsequent time window is after a beginning of the subsequent time window by at least an amount of time needed for charging; and
if it is established that the ignition time for the cylinder assigned to the subsequent time window is after the beginning of the subsequent time window by less than the amount of time needed for charging, starting of a charging process for the ignition device of the cylinder assigned to the subsequent time window.

2. The method as recited in claim 1, wherein the charging process for the ignition device of the cylinder assigned to the subsequent time window begins at a point in time which precedes the ignition time by at least the amount of time needed for charging.

3. The method as recited in claim 1, wherein a start of a charging process for an ignition device for a cylinder assigned to a current time window is suppressed if it is established that the charging process for the ignition device of the current cylinder has already been started.

4. The method as recited in claim 1, wherein in one engine operating mode at least one of the cylinders is passive and the other cylinders are active, a torque caused by the at least one passive cylinder being taken into account when establishing whether the ignition time for the cylinder assigned to the subsequent time window is after the beginning of the subsequent time window by at least the amount of time needed for charging.

5. The method as recited in claim 4, wherein starting of a charging process for an ignition device and triggering of an ignition are suppressed in a time window which is assigned to the at least one passive cylinder.

6. The method as recited in claim 1, wherein a respective time window includes a point in time of a top dead center of a motion of a piston in a cylinder assigned to the time window.

7. A control unit for operating an internal combustion engine having several cylinders, wherein the control unit is adapted to perform, in each one of successive time windows, each of which is assigned to a cylinder, ascertaining information for an ignition time for a cylinder assigned to a subsequent time window, establishing whether the ignition time for the cylinder assigned to the subsequent time window is after a beginning of the subsequent time window by at least an amount of time needed for charging, and if it is established that the ignition time for the cylinder assigned to the subsequent time window is after the beginning of the subsequent time window by less than the amount of time needed for charging, then a charging process for an ignition device of the cylinder assigned to the subsequent time window is started.

8. An engine system, comprising:
a plurality of cylinders; and
a control unit adapted to perform in each one of successive time windows, each of which is assigned to a cylinder, ascertaining information for an ignition time for a cylinder assigned to a subsequent time window, establishing whether the ignition time for the cylinder assigned to the subsequent time window is after a beginning of the subsequent time window by at least an amount of time needed for charging, and if it is established that the ignition time for the cylinder assigned to the subsequent time window is after the beginning of the subsequent time window by less than the amount of time needed for charging, then a charging process for an ignition device of the cylinder assigned to the subsequent time window is started.

9. A memory device storing a computer program, the computer program, when executed by a control unit, causing the control unit to perform, in each of successive time windows, each time window assigned to a cylinder, the steps of ascertaining information for an ignition time for a cylinder assigned to a subsequent time window, establishing whether the ignition time for the cylinder assigned to the subsequent time window is after a beginning of the subsequent time window by at least an amount of time needed for charging, and if it is established that the ignition time for the cylinder assigned to the subsequent time window is after the beginning of the subsequent time window by less than the amount of time needed for charging, then a charging process for an ignition device of the cylinder assigned to the subsequent time window is started.
